(19) United States
(12) Patent Application Publication
(10) Pub. No.: US 2020/0137590 A1
(43) Pub. Date: Apr. 30, 2020

(54) CONSIDERATIONS IN WIRELESS NETWORKS THAT SUPPORT BEAM STEERING MOBILE DEVICES

(71) Applicant: Antenum, Inc., Merrimack, NH (US)

(72) Inventors: John T. Apostolos, Lyndeborough, NH (US); James D. Logan, Candia, NH (US); William Mouyos, Windham, NH (US)

(21) Appl. No.: 16/666,690

(22) Filed: Oct. 29, 2019

Related U.S. Application Data
(60) Provisional application No. 62/752,153, filed on Oct. 29, 2018.
(60) Provisional application No. 62/753,212, filed on Oct. 31, 2018.

(51) Int. Cl. H04W 16/28; H04L 5/14; H04B 7/10; H04B 7/06; H04W 36/00

(52) U.S. Cl. CPC H04W 16/28; H04L 5/14; H04W 36/0005; H04B 7/0617; H04B 7/10

(57) ABSTRACT

A wireless network accommodates mobile devices that provide directive radiation over multiple frequencies, multiple polarizations, and/or operate in modes that reduce unnecessary radiation into a nearby human body.

### REFERENCE TO RELATED APPLICATIONS

This application claims priority to a co-pending U.S. Provisional Patent Application entitled “Considerations in Wireless Networks that Support Beam Steering Mobile Devices”, Ser. No. 62/752,153 filed Oct. 29, 2018 and a co-pending U.S. Provisional Patent Application entitled “Considerations in Wireless Networks that Support Beam Steering Mobile Devices”, Ser. No. 62/753,212 filed Oct. 31, 2018, the entire contents of which are hereby incorporated by reference.

### BACKGROUND

### Technical Field

This application relates to wireless communication networks that support mobile devices capable of steering an antenna beam in different directions.

### Background Information

Handheld wireless devices such as smartphones have typically used a monopole antenna. The designers of emerging 5G and other wireless networks have increasingly realized that directional antennas can be quite useful. A directional antenna, also known as a beam steering antenna, radiates or receives greater power in one or more controllable directions. Directional antennas can thus provide increased range, better performance, reduced interference from unwanted sources, and other benefits.

Antenna arrays that provide directive radiation over multiple frequencies, multiple polarizations are known. The arrays are particularly adapted for use with handheld wireless devices, such as smartphones, tablets, and cellular phones.

See for example U.S. Pat. No. 10,135,122 entitled “Super Directive Array of Volumetric Antenna Elements for Wireless Device Applications”. Antennas can also be arranged as Multiple Input Multiple Output (MIMO) arrays to provides spatial- and temporal multiplexing with polarization independent operating modes, such as described in a co-pending U.S. Patent Publication US2018/0287671 entitled “Directional MIMO Antenna”. The entire contents of each of these applications is incorporated by reference.

Government regulatory authorities such as the United States Federal Communications Commission (FCC) specify a maximum Specific Absorption Rate (SAR) for radiation emitted from wireless devices. Such regulations, as well as a general concern over potentially adverse health effects resulting from increased concentrated radio frequency emissions from directional antennas, have limited their widespread adoption.

### SUMMARY

In one embodiment, various operating modes of wireless system devices are modified to better accommodate mobile devices that have beam forming antennas.

For example, a mobile device such as a smartphone may have a directive antenna array formed of multiple radiating elements. One or more beam forming networks steer the radiation pattern, or main beam(s) of the antenna in one or more directions simultaneously. Selectable coupling networks also provide Circular Left Hand (LH), Circular Right Hand (RH) and/or Linear (horizontal, and/or vertical) polarizations for the antenna beam(s). Components such as filters, meander lines or capacitors may be used to tune a resonant frequency of the antenna.

Two or more cooperating base stations may now each simultaneously communicate to or from the mobile device from two or more different azimuthal directions. This arrangement can, in turn, be used to multiply the available bandwidth for data communication over a given uplink or downlink.

Increased bandwidth is also available other ways, such as by assigning two or more different polarizations at a given frequency (or code) to the same link.

In the case of voice communication, full simultaneous duplex on a given frequency (or code) is now possible by assigning one polarization to the uplink direction, and another polarization to the downlink.

The ability to now reach base stations beyond the range of what would be a normal cell boundary enables new types of load balancing among neighboring base stations.

In one approach, handoff processing takes into account the fact that the mobile device normally transmits with a narrow beam which may be away from a new candidate base station, even when located near a cell boundary. The mobile may now instead be periodically placed in a sweeping beam mode, in an omni mode, or in a difference combiner mode to better detect the presence of candidate base stations for handoff.

Still other advantages are provided by the ability to steer the beam away from a nearby person, even when the closest base station selected would otherwise require transmitting directly through the person.

### BRIEF DESCRIPTION OF THE DRAWINGS

The description below refers to the accompanying drawings, of which:

FIG. 1 illustrates a wireless communication system including several base stations and a mobile device having a beam steering capability.

FIG. 2 is a block diagram of an example beam steering mobile device.

FIG. 3 illustrates one example of the placement of antenna elements in a smartphone.

FIGS. 4A, 4B and 4C are example base station antenna patterns.

FIG. 5 illustrates handoff considerations for a beam steering mobile.

FIG. 6 shows cooperating base stations with the beam steering mobile.

FIG. 7 is a situation where the mobile device is assigned to a base station that is not located within any of the nearest adjacent cells.

FIG. 8 illustrates steering the beam away from a nearby person.

FIG. 9 is an example combining network to obtain Right Hand and Left Hand polarization.

### DETAILED DESCRIPTION OF ILLUSTRATIVE EMBODIMENTS

FIG. 1 depicts a typical wireless communication network that may take advantage of the features and functions described herein. A mobile device M may be a smartphone, laptop computer, cellular phone, personal digital assistant or other wireless communication device that has a beam forming antenna. Mobile device M communicates with one or more base stations A, B, C. The base stations may be mobile telephone Base Transceiver Stations (BTSs) or Base Station Subsystems (BSS), wireless network access points (WAPs), or other fixed location wireless devices in the network. In the case of a mobile network, the base stations (BTSs) may connect to other network devices (not shown) such as Base Station Controllers (BSCs), Mobile Switching Centers (MSCs), Network Switching Subsystems (NSSs) and the like that manage the radio channel resources and controls items such as handover within the group of base stations, allocate channels, and connect traffic to a public telephone or private data network and the like.

Of particular interest here is that the mobile device M has a directional or so-called beam steering antenna array. In particular, the mobile device M has an array of two or more antenna elements such that the radio waves radiated into or received by each individual element combine and superimpose to enhance the power radiated in any specific desired direction. Some arrays are capable of radiating power in two or more directions simultaneously. For example, mobile device M may communicate with both base station A and base station B at the same instant time, on the same frequency and using the same codes (if coded communication is used).

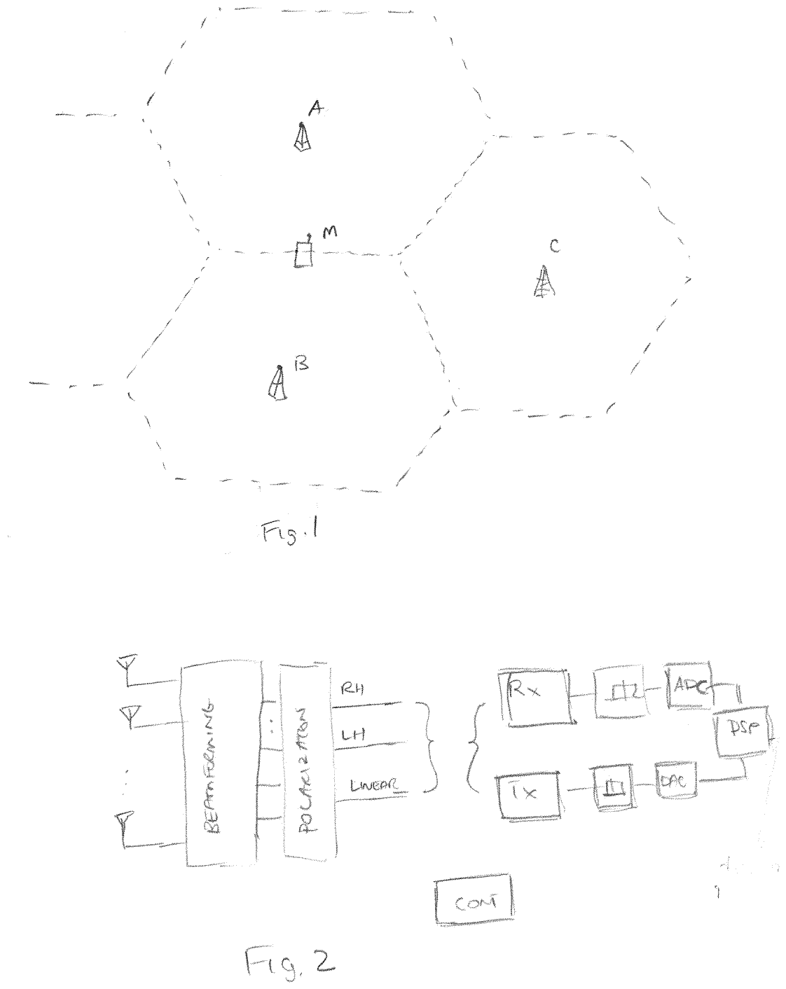

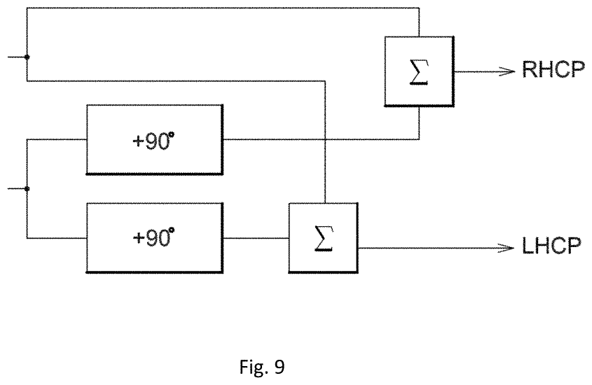

FIG. 2 is a high level diagram of the components of the mobile device M. The multiple antenna elements couple to a beamforming network which in turn couples to a polarization network. The beamforming network steers the array in one or more directions. The polarization network imposes another physical property to the radiated energy, namely a polarization. Selectable polarizations may for example include circular Right-Hand (RH), circular Left-Hand (LH) and linear polarization. More details of the types of combining networks that provide selectable polarization are contained in the patent applications that were already incorporated by reference above. Another combining network consists of a set of 90 degree quadrature combiners located at the output of each antenna element, which may be further weighted and combined to obtain a desired slant. The 0 and 90 degree legs then feed respective ports of a combining network similar to that shown in FIG. 9. A linear combination of the RH and LH outputs may provide Linear polarization, if desired.

In the receive (or downlink) direction, signals output by the polarization network are fed to receiver circuitry which may include radio frequency down conversion, demodulation and decoding circuits, filters, and an analog-to-digital converter which in turn feeds received signals in digital form to a digital signal processor (DSP). In the transmit (or uplink) direction, the DSP feeds a digital analog converter, filters, and transmit circuits which may include modulators, encoders, and up conversion circuits.

Thus, it should be understood that the mobile device uses direction, frequency, (optional coding), and polarization to define different channels on which communication is simultaneously possible.

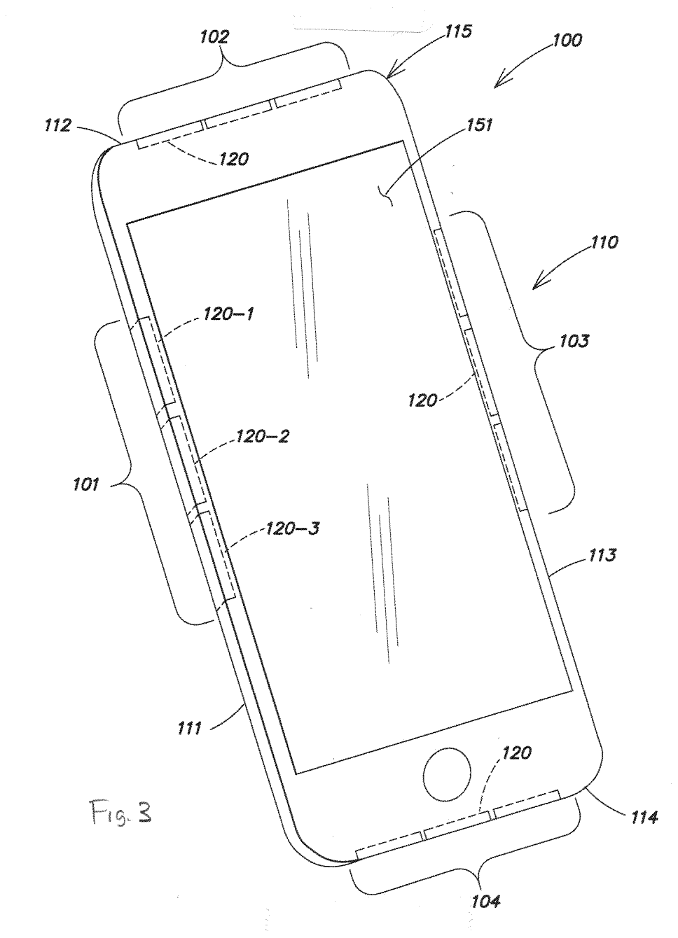

One such antenna array for a mobile device that can provide the directional, frequency, and polarization diversity operation is depicted in FIG. 3. This example device was described in more detail in the above-referenced patent applications. The mobile device 100 may be a cell phone, smart phone, tablet, personal digital assistant, or similar handheld portable communication device. The device 100 uses super directive end fire arrays of volumetric patch antennas conforming to the periphery of the device 100. In the illustrated embodiment, four groups of three radiating elements are disposed around the periphery. In particular, the antenna array 110 consists of four line arrays 101, 102, 103, 104 disposed on along the left edge 111, top edge 112, right edge 113 and bottom edge 114 of a housing 115. An example line array 101 consists of three planar patch elements 120-1, 120-2, and 120-3 disposed along and close to a respective edge of the housing 115. Each line array may be composed of both driven and parasitic elements. In the illustrated configuration, the center element 120-2 is a driven element and elements 120-1 and 120-3 disposed on either side thereof are parasitic. Combinations of selected ones of the four groups of arrays may be used to generate antenna beams in different directions, as more particularly described in U.S. Pat. No. 10,135,122 entitled “Super Directive Array of Volumetric Antenna Elements for Wireless Device Applications” incorporate by reference.

However, by now inserting bandpass filters to pass only the respective frequencies to or from the driven elements, it is also possible to generate a different beam for different frequencies at the same time.

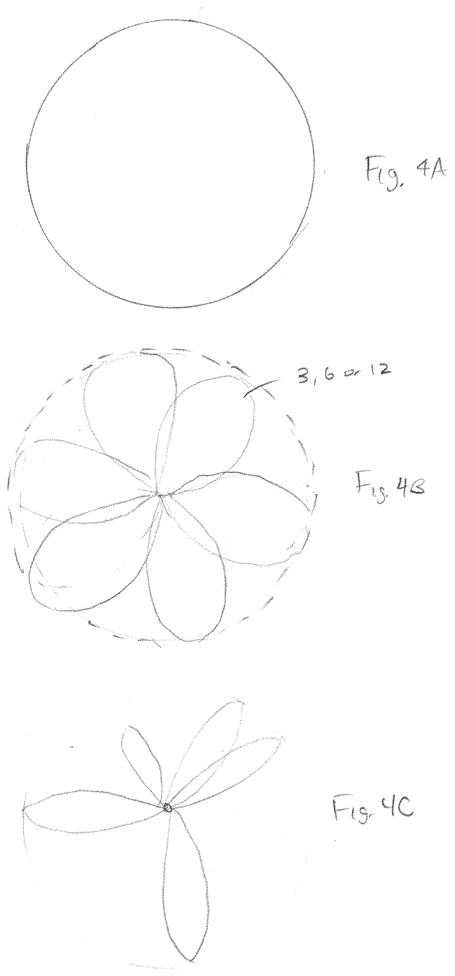

Base stations A,B, and C may or may not themselves use antennas that are capable of beam steering. In one simple embodiment shown in FIG. 4A, some of the advantages described below are provided by a base station that uses an omni-directional radiation pattern. Still other implementations use the approach of FIG. 4B, where the base station antennas are sectorized (for example radiate into 3, 6, or 12 fixed sectors in each cell). However, in other embodiments as suggested by FIG. 4C, the base station antennas made provide individual steerable beams to communication with particular mobile devices located about the cell in different respective directions from the base station antenna.

Having mobile devices M that can communicate over channels defined by frequency, polarization, and directional diversity provides a number of different operational considerations for the network. These include the assignment of channels, hand off processing, and other functions provided by the base stations and/or coordinated between the base stations and the mobile devices.

Referring now to FIG. 5, with mobile stations M capable of receiving signals with different directions and polarizations, it is now possible to increase the capacity of the network in several different ways. Consider that a given base station A may transmit to a first mobile device M2 on a given frequency in a given direction with a first polarization such as right-hand (RH). Base station A may also now transmit to another mobile device M3 that is near mobile M2 at the same time and at the frequency and in the same direction, but with a different polarization.

This additional degree of freedom in separating channels can provide additional desirable characteristics. For example, a full-duplex voice connection can now be provided to a given mobile device M3 by using one polarization, such as right-hand polarization in uplink direction, and a different polarization such as linear polarization, in the downlink direction.

When transmitting data, bandwidth (capacity) for both an uplink and downlink can now also be increased by assigning different polarizations. For example, a given mobile device M2 may now simultaneously receive data on two downlink channels from the same base station A (say one channel having left-hand and the other having right-hand polarization), and still resolve them.

It is expected that leveraging polarization diversity to provide full duplex voice or increased data rates should work fairly well in rural areas, where line of sight propagation is the norm and expected for the signals emitted with directional antennas.

In urban environments where multipath is possible, polarization information on transmitted signals may be lost. However, additional processing may be used in these situations to resolve the differently polarized signals. For example, it is possible that a downlink signal transmitted from a base station A with a circular, right-hand polarization may reflect off of a building, and lose its circular polarization before arriving at the mobile device M2. When this situation is detected, a channel state estimation process may be used to characterize the channel. One such approach has the base station and mobile periodically enter an estimation state where the base station broadcasts a known training (e.g., Barker) sequence to the mobile station. The mobile station may compare (correlate) that received signal to the training sequence that was expected. The result of that comparison can then be used to characterize the channel distortion caused by the multipath propagation. The channel characterization can then be used, e.g., in a matched filter process, to remove such distortion when returning to the normal communication mode.

FIG. 5 also illustrates a consideration during handoff. Consider the case where a mobile device M is initially located within the cell controlled by base station A. Its antenna is pointed in the direction of base station A (in FIG. 5, in an approximately southwest direction). Mobile station M then begins to move east (in the direction of the arrow) where it will eventually be closer to the cell controlled by base station B. Conventional handoff techniques have the mobile station M continuously comparing a receive signal strength from base station A and base station B to determine when to make the switch. However, this approach will not work well (or not work at all) in this instance because of M's use of a directional antenna. In other words, mobile M, point back at base station A, will not properly detect the cell boundary point at which it should switch to base station B control.

A couple of steps can be taken, however, to ensure that mobile station M changes direction to point to base station B closer to the cell boundary. In one solution, mobile M periodically switches to an omnidirectional mode where it can then determine the relative received signal strength (and thus approximate its distance) from base station A and B.

In this omnidirectional mode, the mobile can thus act as a legacy device, and participate in handoff protocols that are similar to the hard and/or soft handoff used in legacy networks (such as used in AMPS, TDMA, GSM, IS-95, IS-136, 3GPP or LTE etc.) using the signal strength measurements made in omnidirectional mode. Once handoff is complete, and a new candidate base station identified, the mobile M might then switch from omni to the directional mode to obtain the benefit of increased SNR and reduced interference for substantive communication.

In another approach, mobile M periodically operates its directional antenna in a directional search or sweeping mode where it scans through a range of directions to determine if it is now close enough to handoff to base station B.

And in yet another approach mobile M may use a beamforming network that has a difference output that provides a mirror image of its primary antenna beam. In that case, this in effect permits the mobile station to generate a complimentary beam, aiming at what is in an opposite direction or behind it. The signal received on the difference port is then used in making handoff decisions, rather than the main beam signal.

In short, is now also possible to use available beam direction as another consideration in making handoff decisions, or use omni mode for handoff decisions, and the directional modes only for sending substantive traffic.

It is also possible that a selected base station A is an older station that only operates legacy protocols, and base station B operates with the improved protocols described herein. In that case, the mobile M may determine these base station types, such as from base station identification information broadcast or sent on a control channel. Mobile M can thus use the legacy handoff (other legacy protocols) when communicating with base station A, but then switch to using the improved directional beam steering based handoff (and other processing modes or protocols) when in communication with base station B.

FIG. 5 also illustrates another situation which occurs uniquely with directional-antenna-enabled mobiles. Consider that a base station A may be currently servicing many mobile devices M, M2, M3, . . . , Mn. A neighboring base station B may be far less busy than base station A. This condition is detected by base stations A and B periodically polling each other, or reporting their load status to another system component such as a BSC, BSS or MSC (not shown). When base station A is in a particularly crowded or overloaded state, a decision may be made to handoff mobile M to base station B even though mobile M is not located within B's normal cell boundary. This decision to handoff may thus be made, in spite of what a distance or signal strength measurement alone might dictate. In other words, with base stations A and B reporting their relative load, and with directional-enabled mobiles, a more optimal load sharing is now possible.

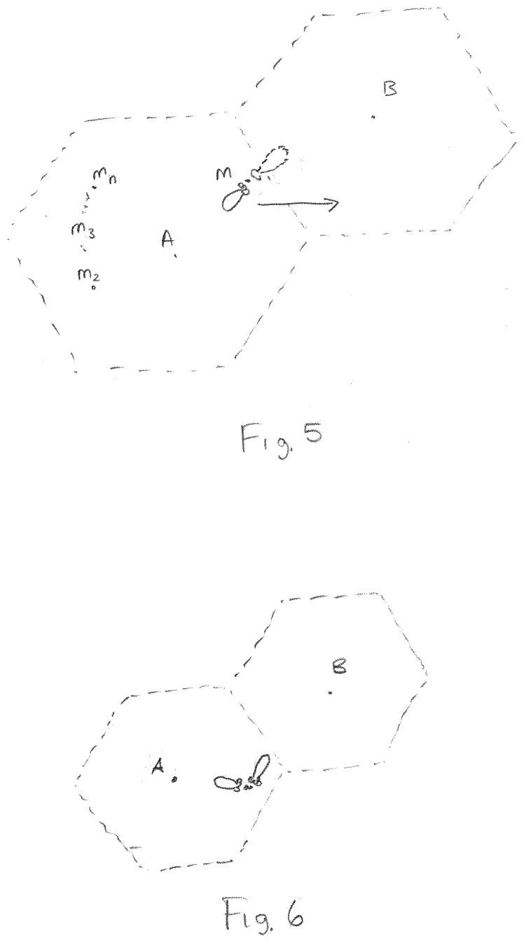

FIG. 6 is a situation that can be now be better supported with a mobile M having an antenna capable of forming multiple simultaneous beams in different directions. The mobile M can now communicate at the same time with both base station A and base station B. For example, mobile M may receive data in a downlink direction from both base stations at the same time. This cooperative base station operating mode thus can increase the bandwidth available to a given mobile M. It should be understood that in in FIG. 6, base stations A and B can each use conventional omnidirectional or sectorized antennas and need not themselves use directional beam steering.

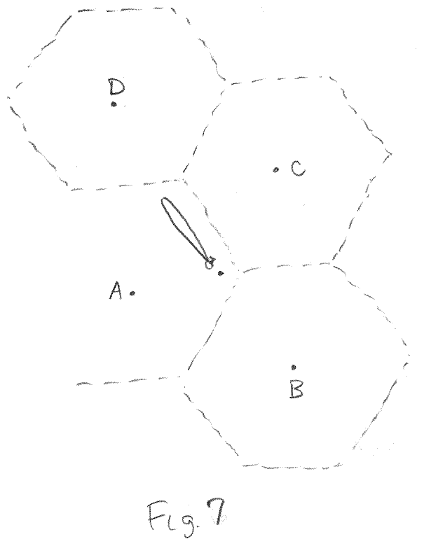

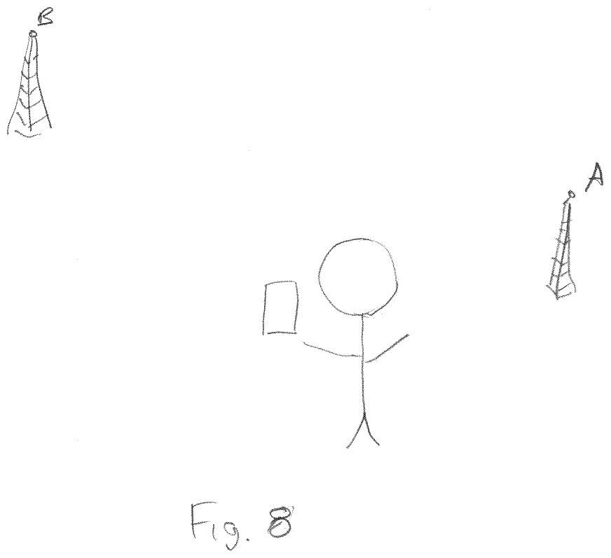

FIG. 7 illustrates another situation where mobile device M is located near a boundary of three adjacent cells A, B, C. Conventional handoff processes would normally thus pick one of these closest base stations A, B or C to service mobile M. Now, however, where operating conditions such as load on A, B and C, or poor propagation conditions around hilly terrain, mobile station M may now be instructed to form a beam in the direction of a distant, non-adjacent base station D. This in effect allows a directional beam to travel “along a gap” between what might otherwise be the fixed boundaries of base stations B and C.

In some implementations, the mobile device may provide additional information for use by the beamforming network (FIG. 2). Many smart phones now contain accelerometers or other sensors that provide information about their vertical and/or horizontal orientation with respect to the ground. These vertical (V) and horizontal (H) orientation data may then be used to weight corresponding horizontal or vertical component inputs in the beamforming network. In one example, these internal sensors (GPS, accelerometers, inclinometers) can be used to adjust the amplitude at each port, and thus maintain axial ratio quality as the mobile device moves in space.

In other words, knowing the physical orientation of the mobile device may be used to more precisely generate the beam. In one approach, the H and V outputs from the accelerometers (or other orientation sensors) in the smartphone would be used to weight the Hpol and Vpol ports as shown, for example, in the beamformers shown in the above-referenced patent applications.

FIG. 8 illustrates another situation that is often of concern. Government regulatory authorities such as the United States Federal Communications Commission (FCC) specify a maximum specific absorption rate (SAR) for the radiation emitted from wireless devices. In the scenario shown in FIG. 8, where the mobile is communicating with base station A, the user's head is partially (or even directly and completely) within the radiation path. The radiated power levels of the device may have been chosen assuming an omni-directional antenna. However, when the mobile device contains a directional antenna array, such as contemplated herein, most of its transmitted energy may pass directly through a concentrated area—and that concentrated area may be located squarely in the user's head. Thus, an undesirable situation may develop where the user is exposed to more radiation than permitted by the SAR regulations.

A solution to this problem can be provided with particular method of operation as follows. A human density distribution detector located in the mobile device, such as that described in the above-referenced patent application, may determine the presence and relative direction of a nearby human. One technique detects a change in impedance in the near field by periodically emitting a low-frequency radio signal and observing a response and/or reflection in the form of a mismatch in the Voltage Standing Wave Ratio (VSWR). A controller in the mobile device may scan the directional array through a number of directions with the low-frequency radio signal and determine the response for each of multiple directions. The controller can then make a decision as to where the radiated power should be directed in order to reduce exposure to a nearby human. This condition may be reported to the base station (or BSC, BSS, or MSS) which may now instead command the mobile device to direct its energy to base station B, located in a direction away from the user's head.

If a change in direction to base station B is not possible, and only base station A is available, the mobile may be commanded to reduce its radiated power and/or to instead operate in an omnidirectional mode.

It should be understood that the embodiments described above are but some examples and the various components may be implemented in many different ways. For example, the component illustrations, block diagrams, circuit schematics, and network diagrams may include more or fewer elements, be arranged differently, or be represented differently. Accordingly, further embodiments may also be implemented in a variety of ways, and thus the components described herein are intended for purposes of illustration only and not as a limitation of the embodiments.

It should also be understood that the “processors” and “controllers” described herein may each be implemented by fixed digital circuits, programmable circuits, a programmable digital signal processor, or a physical or virtual general purpose computer having a central processor, memory, disk or other mass storage, communication interface(s), input/output (I/O) device(s), and other peripherals. The general purpose computer is transformed into the specialized, novel processors and executes the novel processes described above, for example, by loading software instructions into the processor, and then causing execution of the instructions to carry out the functions described. Embodiments may therefore typically be implemented in hardware, firmware, software, or any combination thereof

Embodiments may also be implemented as instructions stored on a non-transient machine-readable medium, which may be read and executed by one or more procedures. A non-transient machine-readable medium may include any mechanism for storing or transmitting information in a form readable by a machine (e.g., a computing device). For example, a non-transient machine-readable medium may include read only memory (ROM); random access memory (RAM); magnetic disk storage media; optical storage media; flash memory devices; and others.

Furthermore, firmware, software, routines, or instructions may be described herein as performing certain actions and/or functions. However, it should be appreciated that such descriptions contained herein are merely for convenience and that such actions in fact result from computing devices, processors, controllers, or other devices executing the firmware, software, routines, instructions, etc.

Thus, while this invention has been particularly shown and described with references to example embodiments thereof, it will be understood by those skilled in the art that various changes in form and details may be made therein without departing from the scope of the invention encompassed by the appended claims.

What is claimed is:

1. A method for operating a wireless communication network comprising:
controlling at least one of (a) a handoff process or (b) assignment of a mobile device to a base station, depending upon a current beam direction of an antenna associated with the mobile device.

2. The method of claim 1 wherein or more cooperating base stations each simultaneously communicate to or from the mobile device from two or more different azimuthal directions, to thereby increase the available bandwidth.

3. The method of claim 1 additionally comprising:
assigning two or more different polarizations at a given frequency (or code) to a same uplink or downlink.

4. The method of claim 1 for providing voice communication additionally comprising:
providing full simultaneous duplex on a given frequency and/or coded channel by assigning one polarization to an uplink direction, and another polarization to a downlink.

5. The method of claim 1 additionally comprising;
assigning the mobile device to a base station that is located beyond a conventional omnidirectional antenna cell boundary.

6. The method of claim 1 wherein a handoff process additionally comprises:
periodically placing the mobile device in a sweeping beam mode, in an omni mode, or in a difference combiner mode to detect the presence of candidate base stations for handoff.

7. The method of claim 1 additionally comprising;
steering an antenna beam away from a nearby person, even when the closest base station selected would otherwise require transmitting directly through the person.
